(19) United States
(12) Patent Application Publication
(10) Pub. No.: US 2015/0268547 A1
(43) Pub. Date: Sep. 24, 2015

(54) REMOVING AND RECOMBINING A PORTION OF A PROJECTED LIGHT STREAM

(71) Applicant: Lockheed Martin Corporation, Bethesda, MD (US)

(72) Inventor: Edward J. Miesak, Windermere, FL (US)

(73) Assignee: Lockheed Martin Corporation, Bethesda, MD (US)

(21) Appl. No.: 14/222,263

(22) Filed: Mar. 21, 2014

(51) Int. Cl. G03B 21/26

(52) U.S. Cl. CPC G03B 21/26

(57) ABSTRACT

Mechanisms for clipping, or diverting, a portion of a projected light stream and seamlessly recombining the diverted portion with the projected light stream on a display surface are disclosed. A reflective surface having a shape diverts a portion of a projected light stream from a first optical path between a projector and a display surface to an imaging system outside of the first optical path. The imaging system focuses the portion at a focal plane that is coplanar with the display surface to generate a focused portion based at least on a distance between the imaging system and the display surface. The focused portion is issued through an aperture having the shape to combine the focused portion with the projected light stream on the display surface.

### TECHNICAL FIELD

The embodiments relate to a projected light stream of a program, such as a movie, television content, a pay-per-view event, and the like, and in particular to removing, or diverting, a portion of the projected light stream and recombining the portion with the projected light stream at a focal plane of the projected light stream.

### BACKGROUND

A projector presents a program, such as a movie, by projecting a light stream carrying the program onto a display surface, such as a screen. Projectors, particularly those used in commercial venues such as movie theaters, cost a substantial amount of money. There are situations in which it would be advantageous to add or alter the content of a program at the venue in which it is being projected, such as to add subtitles to the movie. If the projector does not have the ability to add the content in the desired manner, replacement of the projector with one that does may be impractical, or impossible.

Diverting, or clipping, a portion of a projected light stream for the purpose of modifying the portion will cause the waveform of the projected light stream to diffract along the perimeter of the diverting surface. Such diffraction will cause a blurred edge on the display surface that separates the projected light stream from the dark area formed by the absence of light due to the diverting surface. If the diverted, or clipped, portion is refocused and issued back to the display surface, the refocused portion will have sharp edges that will not visually merge with the blurred edges on the display surface, resulting in a visual distinction between the projected light stream and the refocused portion, which may be unsatisfying to a viewer.

### SUMMARY

The embodiments relate to clipping, or diverting, a portion of a projected light stream and recombining the diverted portion with the projected light stream on a display surface seamlessly such that a viewer is unable to discern that the portion of the projected light stream was ever diverted from the projected light stream. In one embodiment, the diverted portion may be modified to include information, such as subtitles, for example.

In one embodiment a method is provided. A reflective surface having a shape diverts a portion of a projected light stream from a first optical path between a projector and a display surface to an imaging system outside of the first optical path. The imaging system focuses the portion at a focal plane that is coplanar with the display surface to generate a focused portion based at least on a distance between the imaging system and the display surface. The imaging system issues the focused portion through an aperture having the shape to combine the focused portion with the projected light stream on the display surface.

The projected light stream forms a first diffraction pattern on the display surface based on the shape of the reflective surface. The focused portion forms a second diffraction pattern on the display surface based on the shape of the aperture. The first diffraction pattern and second diffraction pattern are complementary, and thus, the viewer is unable to distinguish a difference between the projected light stream and the focused portion.

In one embodiment, the focal plane of the projected light stream is coplanar with the display surface, and the portion of the projected light stream is diverted prior to the focal plane of the projected light stream.

In one embodiment, the portion of the projected light stream is focused at an intermediate focal plane, and the portion is modified at the intermediate focal plane. In one embodiment, the projected light stream comprises program content, and the portion comprises a program content portion. The program content portion is modified at the intermediate focal plane to include information. The information may comprise, for example, subtitles.

In one embodiment, the reflective surface has a first rectangular shape, and the aperture has a second rectangular shape. The first rectangular shape has a first aspect ratio based on a width of the first rectangular shape and a height of the first rectangular shape, and the second rectangular shape has a second aspect ratio based on a width of the second rectangular shape and a height of the second rectangular shape. The second aspect ratio is the same as the first aspect ratio.

In another embodiment, a system is provided. The system includes a reflective surface that has a shape configured to divert a portion of a projected light stream from a first optical path between a projector and a display surface to an imaging system outside of the first optical path. The system also includes a surface that forms an aperture having the shape. An imaging system is configured to focus the portion at a focal plane that is coplanar with the display surface to generate a focused portion based at least on a distance between the imaging system and the display surface. The imaging system is also configured to issue the focused portion through the aperture to combine the focused portion with the projected light stream on the display surface.

In one embodiment, the projected light stream forms a first diffraction pattern on the display surface based on a shape of the reflective surface, and the portion forms a second diffraction pattern on the display surface based on the shape of the aperture, and the first diffraction pattern and second diffraction pattern are complementary.

In one embodiment, the imaging system further comprises a first lens arrangement configured to focus the portion of the projected light stream at an intermediate focal plane. A panel disposed at the intermediate focal plane is configured to modify the portion. A second lens arrangement is configured to focus the portion at the focal plane that is coplanar with the display surface to generate the focused portion based at least on the distance between the second lens arrangement and the display surface.

In another embodiment, another method is provided. A portion of a program is clipped from a projected light stream that is focused on a display surface. The portion is refocused to generate a refocused portion that has a focal plane that is coplanar with the display surface. The refocused portion is directed through an aperture to combine the refocused portion with the projected light stream on the display surface.

Those skilled in the art will appreciate the scope of the disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A is a block diagram of a system in which embodiments may be practiced;

FIG. 1B is a block diagram of the system illustrated in FIG. 1A after a portion of a projected light stream has been recombined with the projected light stream according to one embodiment;

FIG. 2 is a flowchart of a method according to one embodiment;

FIG. 3 is a flowchart of another method according to one embodiment;

FIG. 4 is a block diagram of an optical flow of a projected light stream and a clipped or diverted portion according to one embodiment;

FIG. 5 is a block diagram of another system according to one embodiment;

FIG. 6A illustrates a transparent structure that holds a reflector at a desired location within the projected light stream according to one embodiment;

FIG. 6B illustrates a top view of the transparent structure illustrated in FIG. 6A; and

FIG. 7 is a block diagram of an imaging system according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first optical path” and “second optical path,” and does not imply a priority, a type, an importance, or other attribute, unless otherwise stated herein.

The embodiments relate to clipping, or diverting, a portion of a projected light stream and recombining the diverted portion with the projected light stream on a display surface seamlessly such that a viewer is unable to discern that the portion of the projected light stream was ever diverted from the projected light stream. The terms “clipping” and “diverting” are used herein synonymously. The embodiments have applicability in a number of different applications, including, by way of non-limiting example, examining the content of the portion of the projected light stream, modifying the portion of the projected light stream, or adding content to the portion of the projected light stream.

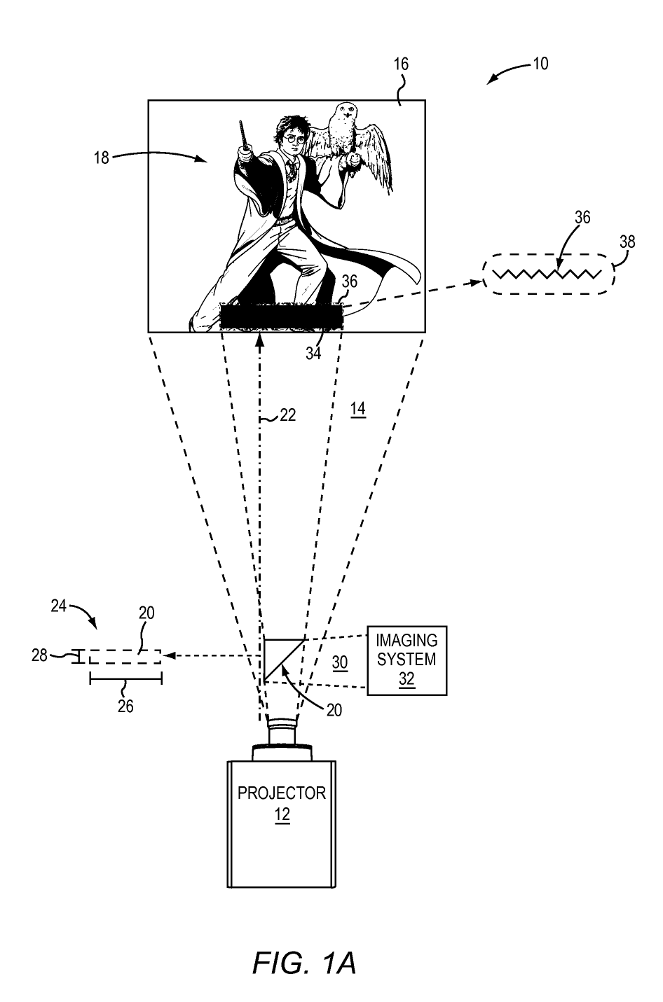

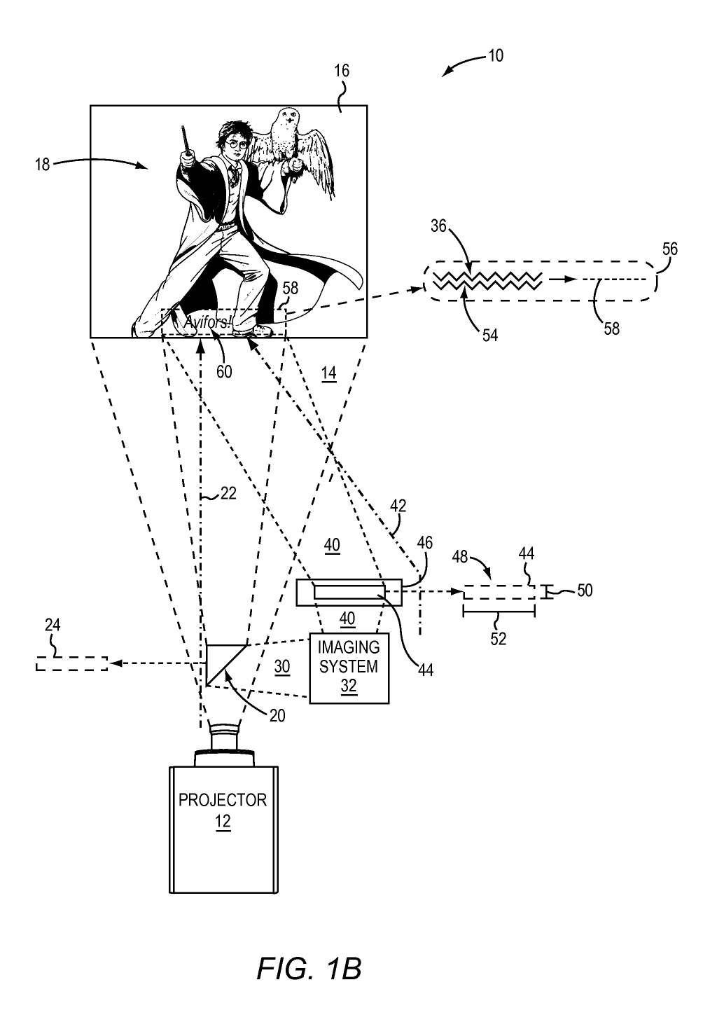

FIG. 1A is a block diagram of a system 10 in which embodiments may be practiced. The system 10 includes a projector 12 that projects, or otherwise presents, a projected light stream 14 on a display surface 16 for viewing. The projected light stream 14 carries content 18, such as program content, for presentation to a viewer (not illustrated). The projector 12 may comprise any type of projector capable of projecting the content 18 via the projected light stream 14, including, by way of non-limiting example, a digital light processing (DLP) projector, a liquid crystal display (LCD) projector, or a laser projector. The program may comprise any program capable of being projected, such as, by way of non-limiting example, a movie, a television program, a live video, a video-on-demand program, or the like. A focal plane of an imaging system of the projector 12 is coplanar with the display surface 16 so that the viewer is presented with focused content 18.

A reflective surface 20 is disposed or otherwise positioned in a first optical path 22 between the projector 12 and the display surface 16 at a location that is prior to the focal plane of the projector 12. The reflective surface 20 may comprise any suitable reflector, such as a mirror. The reflective surface 20 has a shape 24. In this example, the shape 24 is rectangular and has a first aspect ratio based on a width 26 and a height 28 of the shape 24. However, the embodiments are not limited to a rectangular shape, and the shape 24 may comprise any shape, such as a circular shape, a triangular shape, or even an irregular shape. The shape 24 is that what is “seen” by the projected light stream 14. The reflective surface 20 clips, or diverts by reflection, a portion 30 of the projected light stream 14 from the projected light stream 14, and reflects the portion 30 to an imaging system 32 that is outside of the first optical path 22.

FIG. 1A illustrates how the content may appear on the display surface 16 to a viewer if the reflective surface 20 merely diverts the portion 30 and if portion 30 is not subsequently recombined with the projected light stream 14 on the display surface 16. Because the reflective surface 20 blocks the projected light stream 14, a darkened area 34 appears on the display surface 16. Notably, the projected light stream 14 forms a first diffraction pattern 36 that has the shape 24 of the reflective surface 20. The first diffraction pattern 36 is the result of the light rays of the projected light stream 14 diffracting as they pass the edges of the reflective surface 20. While for purposes of illustration an inset 38 illustrates a portion of the first diffraction pattern 36 as a jagged edge, in practice, the diffraction pattern will not appear as a jagged edge, but rather as a blurred outline that circumscribes the darkened area 34.

FIG. 1B is a block diagram of the system 10 illustrated in FIG. 1A after the portion 30 has been recombined with the projected light stream 14 according to one embodiment. The imaging system 32 receives the portion 30 of the projected light stream 14 and focuses the portion 30 at a focal plane that is coplanar with the display surface 16 to generate a focused portion 40 based at least in part on a distance of a second optical path 42 between the imaging system 32 and the display surface 16. The distance of the second optical path 42 differs from that of the first optical path 22, and thus, if the portion 30 is not refocused at the focal plane that is coplanar with the display surface 16, the portion 30, if issued to the display surface 16, will be blurred and, thus, visually distinguishable by a viewer from the rest of the projected light stream 14.

The imaging system 32 issues, such as by projection, transmission, or any other emission mechanism, the focused portion 40 toward an aperture 44 that is formed in an aperture-forming surface 46. The aperture 44 has a shape 48 that is the same shape as the shape 24 of the reflective surface 20. The phrase “same shape” as used herein refers to two shapes wherein the two shapes are identical, or one shape is a scale of the other shape. Thus, although a height 50 of the shape 48 may differ from the height 28 of the shape 24 and a width 52 of the shape 48 may differ from the width 26 of the shape 24, the aspect ratio of the width 52 to the height 50 is the same as the aspect ratio of the width 26 to the height 28, and thus, the shape 48 is a scale of the shape 24. Similarly, if the shape 24 were triangular, the shape 48 would also be triangular, and although the shape 48 may be a different size than the shape 24, the shape 48 would have the same angles as that of the shape 24 and thus would be a scale of the shape 24.

The edges of the aperture 44 cause the focused portion 40 to form a second diffraction pattern 54 due to the light rays of the focused portion 40 diffracting as they pass the edges of the of the aperture 44. The second diffraction pattern 54 is complementary to the first diffraction pattern 36, and thus forms a seamless edge between the projected light stream 14 and the refocused portion 40 at the display surface 16. An inset 56 illustrates, using jagged edges, how a section of the first diffraction pattern 36 complements a corresponding section of the second diffraction pattern 54 and results in a seamless edge 58, represented by a dashed line. The seamless edge 58 is depicted for purposes of illustration but is not seen by a viewer. The viewer is thus unable to discern that the content 18 is the combination of the projected light stream 14 and the focused portion 30. As will be discussed in greater detail herein, in some embodiments, the imaging system 32 may modify the portion 30 to contain additional content, such as, by way of non-limiting example, subtitles 60.

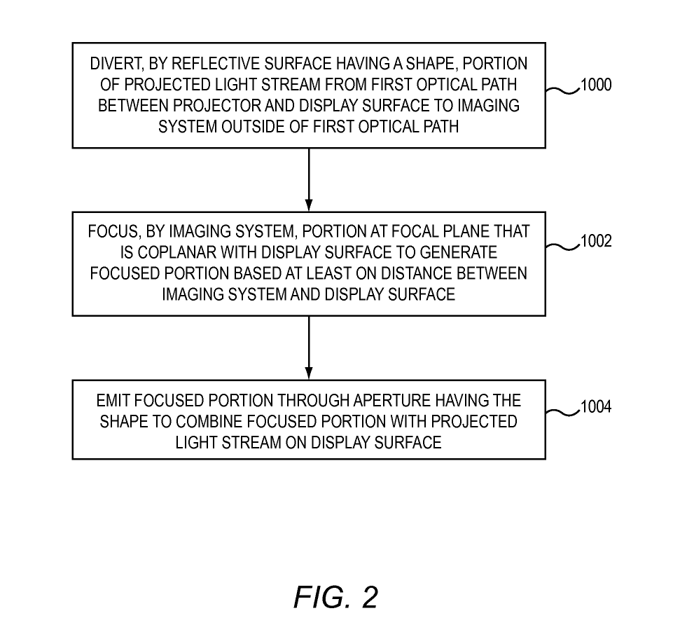

FIG. 2 is a flowchart of a method according to one embodiment, and will be discussed in conjunction with FIG. 1B. The reflective surface 20 diverts the portion 30 of a projected light stream 14 from the first optical path 22 between the projector 12 and the display surface 16 to the imaging system 32 outside of the first optical path 22 (FIG. 2, block 1000). The imaging system 22 focuses the portion 30 at a focal plane that is coplanar with the display surface 16 to generate the focused portion 40 based at least on a distance between the imaging system 32 and the display surface 16 (FIG. 2, block 1002). The imaging system 32 issues the focused portion 40 through the aperture 44 that has the shape 24 to combine the focused portion 40 with the projected light stream 14 on the display surface 16 (FIG. 2, block 1004).

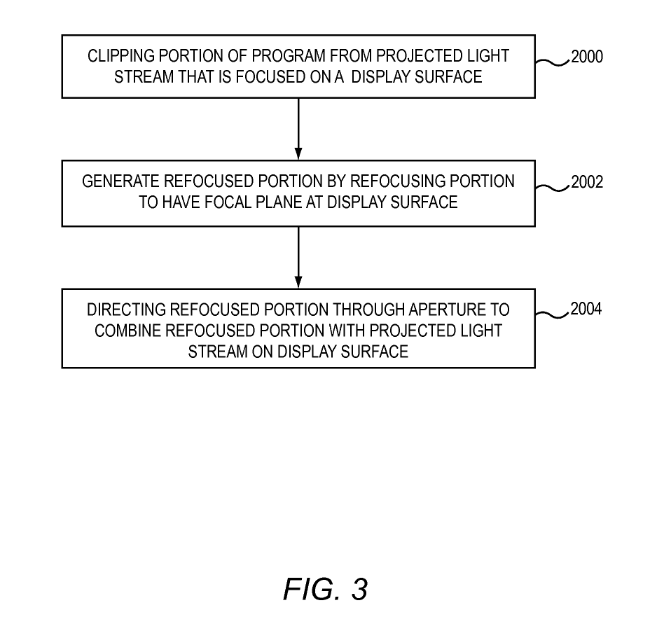

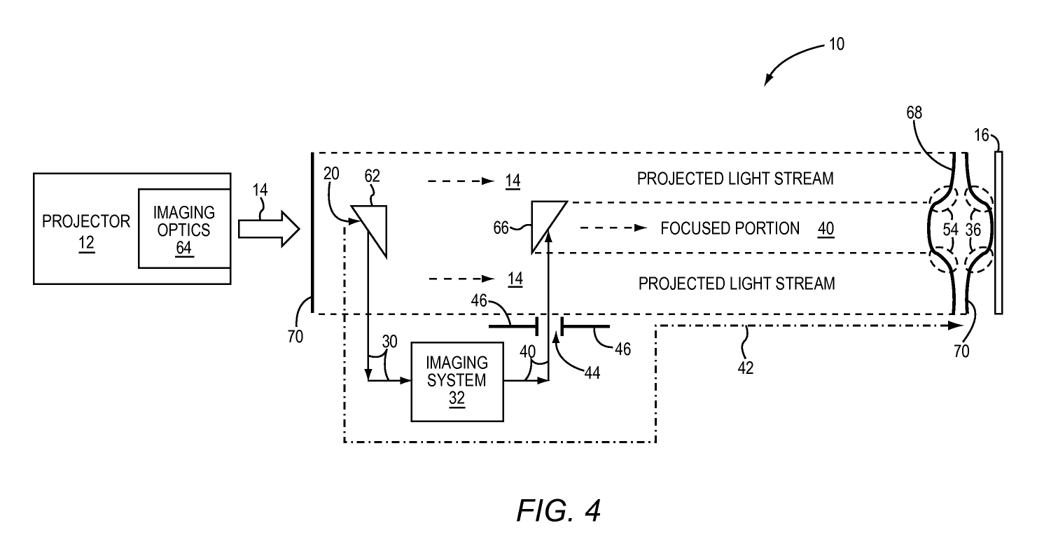

FIG. 3 is a flowchart of another method according to one embodiment, and will be discussed in conjunction with FIG. 1B. The portion 30 of a program from the projected light stream 14 that is focused on the display surface 16 is clipped (FIG. 4, block 2000). The portion 30 is refocused to generate a refocused portion, such as the focused portion 40, that has a focal plane at the display surface 16 (FIG. 4, block 2002). The refocused portion is directed through the aperture 44 to combine the refocused portion (e.g., the focused portion 40) with the projected light stream 12 on the display surface 16 (FIG. 4, block 2004).

FIG. 4 is a block diagram of an optical flow of the projected light stream 14 and the clipped, or diverted portion 30 according to one embodiment. As discussed above, a reflector 62, such as a mirror, is positioned or otherwise disposed in an optical path between the projector 22 and the display surface 16. The reflective surface 20 diverts the portion 30 of the projected light stream 14 from the optical path to the imaging system 32. The imaging system 32 focuses the portion 30 at a focal plane that is coplanar with the display surface 16, at least in part to compensate for the difference in length between the optical path between imaging optics 64 of the projector 12 and the display surface 16 and the optical path between the imaging system 32 and the display surface 16. The imaging system 32 issues the focused portion 40 through the aperture 44 in the aperture-forming surface 46 to cause the second diffraction pattern 54. In this embodiment, the second optical path 42 includes an additional reflector 66 to direct the focused portion 40 to the appropriate location on the display surface 16. A waveform 68 that represents the focused portion 40 and a waveform 70 that represents the projected light stream 14 visually illustrate how the first diffraction pattern 36 complements the second diffraction pattern 54, and how the first diffraction pattern 36 and the second diffraction pattern 54 result in a seamless integration, or combination, of the focused portion 40 with the projected light stream 14.

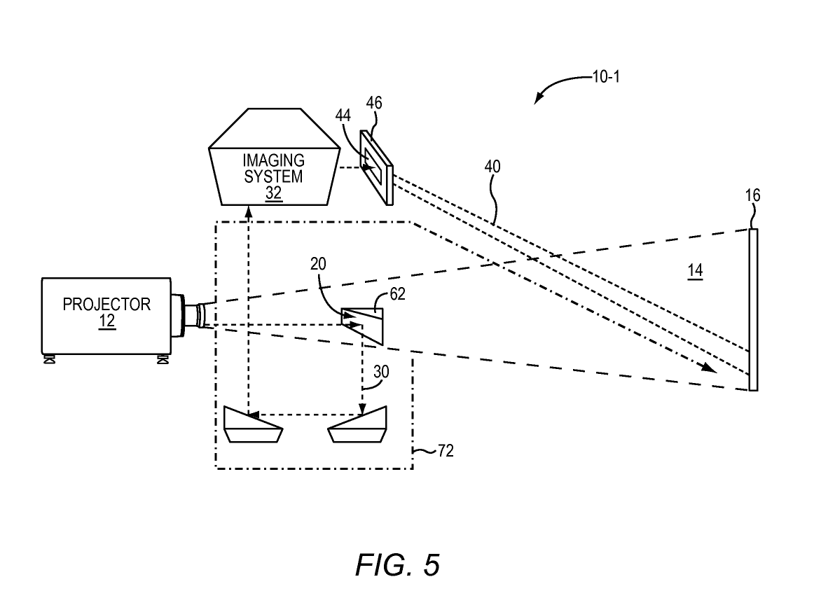

FIG. 5 is a block diagram of a system 10-1 according to one embodiment. The system 10-1 is substantially similar to the system 10 discussed above, but a different second optical path 72 is illustrated, wherein the portion 30 is reflected at multiple locations on the way to the imaging system 32. It will be appreciated that any number of reflective surfaces could be utilized to position the imaging system 32 at a desirable location with respect to the projector 12, including to either side of the projector 12, below the projector 12, or above the projector 12, as illustrated in FIG. 5.

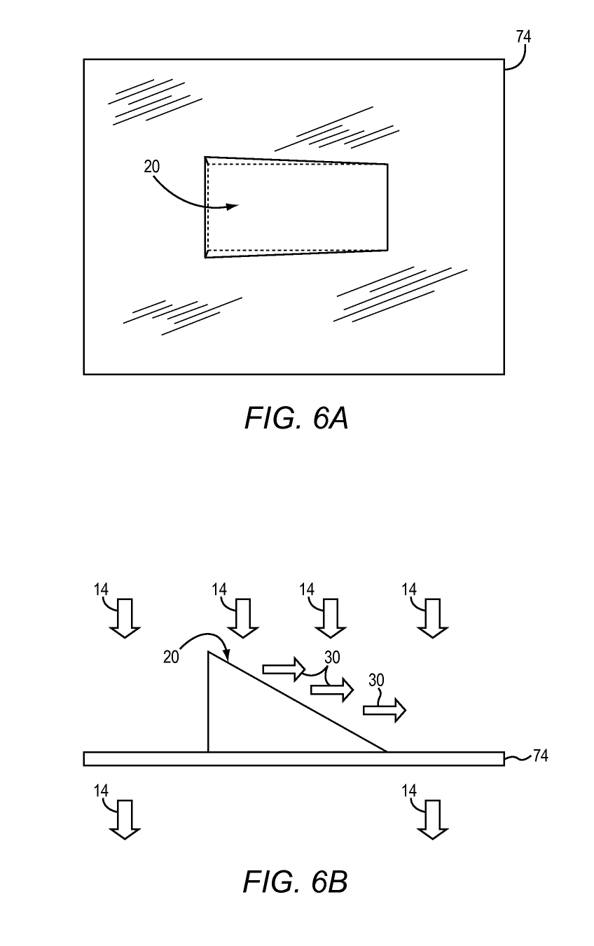

FIG. 6A illustrates a transparent structure 74 that holds the reflector 62 at a desired location within the projected light stream 14. The transparent structure 74 passes the projected light stream 14 unaltered toward the display surface 16, except for that portion 30 of the projected light stream 14 that is diverted by the reflective surface 20. The use of the transparent structure 74 allows the reflective surface 20 to be positioned at any desired location with respect to the projected light stream 14, and thus facilitates the addition of content on the display surface 16 at any desired location on the display surface 16.

FIG. 6B illustrates a top view of the transparent structure 74 illustrated in FIG. 6A. As the projected light stream 14 contacts the reflective surface 20, the portion 30 is diverted along a second optical path that contains the imaging system 32. The projected light stream 14 that does not contact the reflective surface 20 passes through the transparent structure 74 along the first optical path 22 in a direction toward the display surface 16.

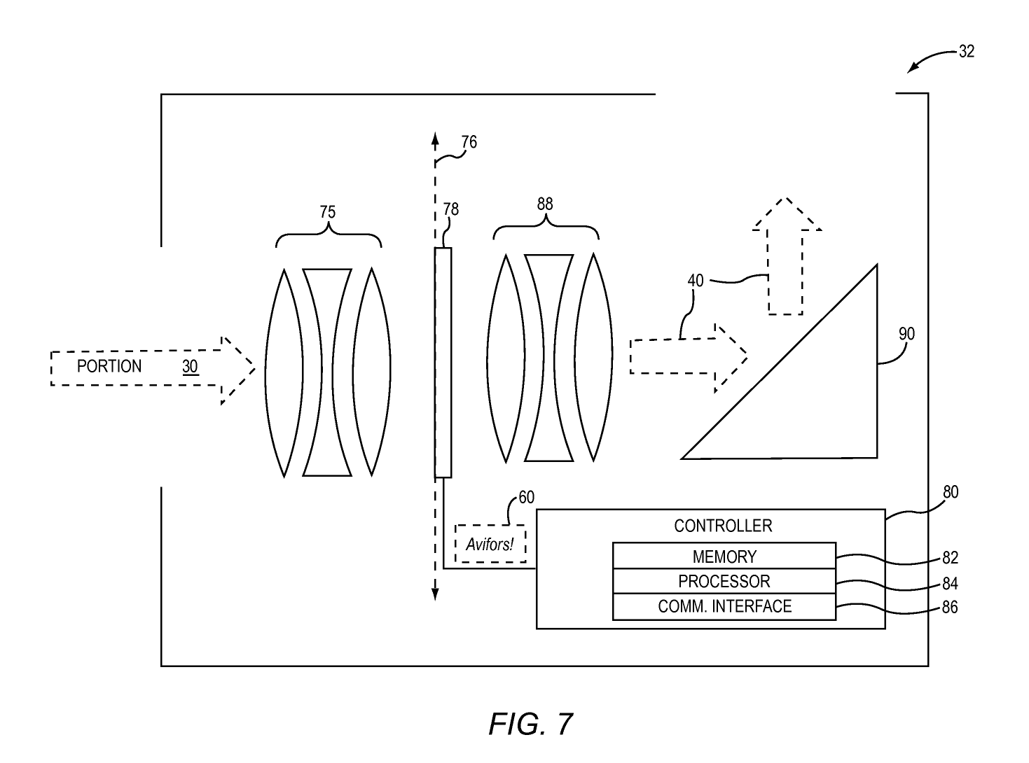

FIG. 7 is a block diagram of the imaging system 32 according to one embodiment. In one embodiment, the projected light stream 14 has a particular polarization orientation, such as vertical or horizontal, and thus, the portion 30 comprises light having a first polarization orientation. The imaging system 32 includes a first lens arrangement 75 that is configured to focus the portion 30 at an intermediate focal plane 76. A panel 78 is disposed at the intermediate focal plane 76 and is configured to modify the portion 30, such as to add subtitles or other content. The panel 78 may comprise any electronic, filter, or other light-altering mechanism. In one embodiment, the panel 78 comprises an LCD array that comprises a plurality of LCD elements. All or a portion of the portion 30 may be altered as it passes through the LCD array, on an LCD-element-by-LCD-element basis. The alteration may be to alter the wavelength of the light passing through one or more LCD elements, to alter a polarization of the light passing through the one or more LCD elements of the LCD array, to alter a phase of the light passing through the one or more LCD elements of the LCD array, or the like. The content, such as subtitles, are thus invisible to an unaided eye of a human and may be perceived by a human wearing glasses configured to present the added content to one or more eyes of the viewer.

The imaging system 32 may also comprise a controller 80 that includes a memory 82, a processor 84, and a communications interface 86. The controller 80 may be configured to control the LCD elements in the panel 78 in a desired manner to include information in the portion 30 as the portion 30 passes through the panel 78.

In particular, in one embodiment, at least some of the LCD elements have multiple modes, including a non-rotation mode and a rotation mode. The non-rotation mode may be associated with an OFF state of an LCD element, and the rotation mode may be associated with an ON state of the LCD element. When in the non-rotation mode, the polarization orientation of light passing through a respective LCD element remains substantially unchanged. When in the rotation mode, the polarization orientation of light passing through the respective LCD element is rotated an offset amount to a first offset polarization orientation that is substantially orthogonal to the first polarization orientation.

The controller 80 obtains the content, in this example subtitle information, and then generates a polarization rotation pattern based on the content. In one embodiment, the controller 80 identifies a group of LCD elements in the LCD array that, based on desired viewing characteristics of the content on the display surface 16, such as height and width, form a pattern that replicates the content.

After the group of LCD elements is identified, and consistent with any timing requirements of adding the content to the portion 30, the controller 80 sets the group of LCD elements in the LCD array to the rotation mode. The polarization orientation of light from the sub-portion of the portion 30 that passes through such group of LCD elements is then rotated the offset amount to give such sub-portion the first offset polarization orientation. Iteratively, over a period of time, such as the duration of the program, this process repeats. Thus, the controller 80 receives new content, determines a new group of LCD elements that form a new polarization rotation pattern based on the new content, sets all the LCD elements in the LCD array to the non-rotation mode to erase the previous polarization rotation pattern, and then sets the LCD elements in the new group of LCD elements to the rotation mode. The timing for the continual presentation of new content in lieu of previous content may be provided separately from the content, or may be implied simply by the presence of new content.

A viewer may wear polarized glasses that passes light having the first polarization orientation and that blocks light having the offset orientation polarization. Thus, the viewer perceives the added subtitle information by virtue of the omission of light in a pattern that is based on the subtitles 60. Viewers not wearing the glasses do not see the subtitles 60, because the subtitles 60 are not visible to the unaided eye.

In some embodiments, the panel 78 may be implemented in a manner such as that disclosed in U.S. patent application Ser. No. 14/208,050, entitled “SYSTEM AND METHOD FOR PROVIDING A POLARIZATION PROJECTOR UTILIZING A POLARIZATION SENSITIVE LENS,” and filed on Mar. 13, 2014, the disclosure of which is hereby incorporated herein by reference in its entirety, to alter the portion 30 to include additional information, such as the subtitles 60. In other embodiments, the panel 78 may be implemented in a manner such as that disclosed in U.S. patent application Ser. No. 14/222,164, entitled “ADDING CONTENT TO A PROGRAM,” filed on Mar. 21, 2014 and having the same named inventor, attorney docket number 1302-231, the disclosure of which is hereby incorporated herein by reference in its entirety, to alter the portion 30 to include additional information, such as the subtitles 60. A second lens arrangement 88 focuses the portion 30 issued from the panel 78 to form the focused portion 40 that has a focal plane that is coplanar with the display surface 16 based at least in part on the distance of the optical path between the second lens arrangement 88 and the display surface 16. Such optical path may include one or more additional optical elements, such as one or more reflectors 90 suitable for directing the focused portion 40 at the desired location on the display surface 16 in order for the second diffraction pattern 54 formed via the aperture 44 to complement the first diffraction pattern 36 of the projected light stream 14. Because the subtitles 60 are implemented via polarization orientation, the subtitles 60 are invisible to an unaided eye of a human.

Those skilled in the art will recognize improvements and modifications to the preferred embodiments of the disclosure. All such improvements and modifications are considered within the scope of the concepts disclosed herein and the claims that follow.

What is claimed is:

1. A method comprising:
diverting, by a reflective surface having a shape, a portion of a projected light stream from a first optical path between a projector and a display surface to an imaging system outside of the first optical path;
focusing, by the imaging system, the portion at a focal plane that is coplanar with the display surface to generate a focused portion based at least on a distance between the imaging system and the display surface; and
issuing the focused portion through an aperture having the shape to combine the focused portion with the projected light stream on the display surface.

2. The method of claim 1, wherein the projected light stream forms a first diffraction pattern on the display surface based on the shape of the reflective surface, and the portion forms a second diffraction pattern on the display surface based on the shape of the aperture, and the first diffraction pattern and the second diffraction pattern are complementary.

3. The method of claim 1, wherein a focal plane of the projected light stream is coplanar with the display surface, and diverting the portion of the projected light stream comprises diverting the portion of the projected light stream prior to the focal plane of the projected light stream.

4. The method of claim 1, further comprising:
focusing the portion at an intermediate focal plane;
modifying the portion at the intermediate focal plane; and
focusing, by the imaging system, the portion at the focal plane that is coplanar with the display surface to generate the focused portion based at least on the distance between the imaging system and the display surface.

5. The method of claim 4, wherein the projected light stream comprises program content, and the portion comprises a program content portion, and further comprising modifying the program content portion at the intermediate focal plane to include information.

6. The method of claim 5, wherein the information comprises subtitles.

7. The method of claim 6, wherein the subtitles are invisible to an unaided eye of a human.

8. The method of claim 1, wherein the shape of the reflective surface comprises a first rectangular shape, and the shape of the aperture comprises a second rectangular shape.

9. The method of claim 8, wherein the first rectangular shape has a first aspect ratio based on a width of the first rectangular shape and a height of the first rectangular shape, and the second rectangular shape has a second aspect ratio based on a width of the second rectangular shape and a height of the second rectangular shape, and the second aspect ratio is the same as the first aspect ratio.

10. The method of claim 1, wherein issuing the focused portion through the aperture having the shape to combine the focused portion with the projected light stream on the display surface further comprises issuing the focused portion through the aperture having the shape to combine the focused portion with the projected light stream on the display surface such that the focused portion and the projected light stream are not visually distinguishable from one another on the display surface.

11. A system comprising:
a reflective surface having a shape configured to divert a portion of a projected light stream from a first optical path between a projector and a display surface to an imaging system outside of the first optical path;
a surface forming an aperture having the shape; and
an imaging system configured to:
focus the portion at a focal plane that is coplanar with the display surface to generate a focused portion based at least on a distance between the imaging system and the display surface; and
issue the focused portion through the aperture to combine the focused portion with the projected light stream on the display surface.

12. The system of claim 11, wherein the projected light stream forms a first diffraction pattern on the display surface based on the shape of the reflective surface, and the portion forms a second diffraction pattern on the display surface based on the shape of the aperture, and the first diffraction pattern and the second diffraction pattern are complementary.

13. The system of claim 11, wherein the imaging system further comprises:
a first lens arrangement configured to focus the portion at an intermediate focal plane;
a panel disposed at the intermediate focal plane and configured to modify the portion; and
a second lens arrangement configured to focus the portion at the focal plane that is coplanar with the display surface to generate the focused portion based at least on a distance between the second lens arrangement and the display surface.

14. The system of claim 13, wherein the projected light stream comprises program content, and the portion comprises a program content portion, and wherein the panel disposed at the intermediate focal plane is configured to modify the program content portion to include information.

15. The system of claim 14, wherein the information comprises subtitles.

16. The system of claim 11, wherein the reflective surface comprises a first rectangular shape, and the aperture comprises a second rectangular shape.

17. The system of claim 16, wherein the first rectangular shape has a first aspect ratio based on a width of the first rectangular shape and a height of the first rectangular shape, and the second rectangular shape has a second aspect ratio based on a width of the second rectangular shape and a height of the second rectangular shape, and the second aspect ratio is the same as the first aspect ratio.

18. The system of claim 11, wherein the imaging system is further configured to issue the focused the focused portion through the aperture having the shape to combine the focused portion with the projected light stream on the display surface such that the focused portion and the projected light stream are not visually distinguishable from one another on the display surface.

19. A method, comprising:
clipping a portion of a program from a projected light stream that is focused on a display surface;
refocusing the portion to generate a refocused portion that has a focal plane that is coplanar with the display surface; and
directing the refocused portion through an aperture to combine the refocused portion with the projected light stream on the display surface.

20. The method of claim 19, wherein clipping the portion of the program from the projected light stream that is focused on the display surface comprises diverting, by a reflective surface, the portion to an imaging system.

21. The method of claim 20, wherein the projected light stream forms a first diffraction pattern on the display surface based on a shape of the reflective surface, and the refocused portion forms a second diffraction pattern on the display surface based on a shape of the aperture, and the first diffraction pattern and second diffraction pattern are complementary.

22. A system comprising:
a reflective surface having a shape configured to divert a portion of a projected light stream from a first optical path between a projector and a display surface to an imaging system outside of the first optical path;
a surface forming an aperture having the shape; and
an imaging system configured to:
modify the portion to include subtitles;
focus the portion at a focal plane that is coplanar with the display surface to generate a focused portion based at least on a distance between the imaging system and the display surface; and
issue the focused portion through the aperture to combine the focused portion with the projected light stream on the display surface.

23. The system of claim 22, wherein the subtitles are invisible to an unaided eye of a human.
